(19) United States
(12) Patent Application Publication
(10) Pub. No.: US 2008/0052944 A1
(43) Pub. Date: Mar. 6, 2008

(54) Enhanced Structure for Measuring Tape

(76) Inventor: Shih Lin Lee, Taipei (TW)

Correspondence Address: HDSL, 4331 STEVENS BATTLE LANE, FAIRFAX, VA, 22033, US

(21) Appl. No.: 11/468,148

(22) Filed: Aug. 29, 2006

(51) Int. Cl. G01B 3/10

(52) U.S. Cl. 33/767

(57) ABSTRACT

A structure for measuring tape includes a slightly I-shaped wheel having a positioning plate extended from the middle thereof, the positioning plate fixedly connecting to a tail portion of a tape of the measuring tape, a winding of the tape around the wheel making the wound tape to be flexible, and the wheel having one side combined with a retracting device; the wheel being disposed in a casing of the measuring tape, and the retracting device on one side of the wheel protruding out of the casing; when a brake portion of the casing being released, a elastic force generated by the winding driving the tape to automatically and continuously eject from a tape outlet of the casing, the tape would stop ejecting when the brake portion clips the tape; when one wants to retract the tape, he/she can use the retracting device protruded out of the casing to turn the wheel in an opposite direction to wind the tape back into the casing to implement the tape ejection/retraction movement.

### BACKGROUND OF THE INVENTION

1. Field of the Invention

The present invention is related to an enhanced structure for measuring tape, and more particularly, to an enhanced structure for measuring tape which lets the tape to eject continuously when no brake is employed and uses a retracting device to wind the tape back into the casing.

2. Description of the Prior Art

Measuring tapes are widely used in all kinds of applications such as home decoration, furnishing, and construction and so on to provide measuring capabilities. Therefore, measuring tapes have become an indispensable measuring equipment in daily life.

In using a traditional measuring tape, one has to pull the tape out of the casing of the measuring tape, then uses the elastic force generated by the spring inside the casing to automatically retract the tape back to the casing. However, this operation is disadvantageous for the following reasons.

1. When one tries to pull out the tape, it is often that the tape quickly returns into the casing of the measuring tape without being fully pulled out to a desired length, making it inconvenient for users to operate.

2. Traditional measuring tape uses a spring disposed inside the casing to quickly retract the tape back into the casing by the elastic force of the spring. Therefore, it is often that the tape could slash one's hand during fast retraction movement of the tape. Meanwhile, the tape could be easily worn out when the tape returns to the casing and rubs against the casing during retraction.

Therefore, the above-mentioned traditional measuring tapes present several shortcomings to be overcome.

In view of the above-described deficiencies of traditional measuring tapes, after years of constant effort in research, the inventor of this invention has consequently developed and proposed an enhanced structure for measuring tape in the present invention.

### SUMMARY OF THE INVENTION

The present invention is to provide an enhanced structure for measuring tape which lets the tape to eject automatically and continuously, while retracts the tape back into the casing manually to facilitate the ejection/retraction of the tape and to avoid hurting users due to fast retraction movement.

The present invention is to provide an enhanced structure for measuring tape which eliminates the use of spring to save cost.

The present invention provides an enhanced structure for measuring tape, which comprises a tape casing, a brake portion, a wheel and a tape; wherein the tape casing is composed of two casing bodies combining with each other, a first casing body having an opening disposed thereon, and a tape outlet being disposed at a lower front side of the tape casing; the brake portion being combined with the front side of the tape casing for clipping and releasing the tape; the slightly I-shaped wheel having a positioning plate extended therefrom, the positioning plate fixedly connecting to a tail portion of the tape, winding of the tape around the wheel making the wound tape to be flexible due to its metallic characteristics; the wheel being disposed in the tape casing with one side of the wheel protruding out of the tape casing, therefore, the retracting device on the side of the wheel also protruding out of the tape casing. When one wants to use the measuring tape, releasing the brake portion on the front side of the tape casing, then a elastic force generated by the winding would drive the tape to automatically and continuously eject from the tape outlet of the tape casing, the tape would stop ejecting when the brake portion clips the tape; when one wants to retract the tape, he/she can use the retracting device protruded out of the tape casing to turn the wheel in an opposite direction to wind the tape back into the tape casing to implement the tape ejection/retraction movement.

These features and advantages of the present invention will be fully understood and appreciated from the following detailed description of the accompanying Drawings.

### BRIEF DESCRIPTION OF THE DRAWINGS

FIG. 1 illustrates a perspective view of an enhanced structure for measuring tape in the present invention;

FIGS. 2A and 2B illustrate the enhanced structure for measuring tape in the present invention in 3D views;

FIG. 3 illustrates an embodiment of the enhanced structure for measuring tape in the present invention;

FIG. 4 illustrates another embodiment of the enhanced structure for measuring tape in the present invention;

FIGS. 5A, 5B and 5C illustrate the enhanced structure for measuring tape in which the tape is being released; and

FIGS. 6A and 6B illustrate the enhanced structure for measuring tape in which the tape is being retracted.

### DETAILED DESCRIPTION OF THE PREFERRED EMBODIMENT

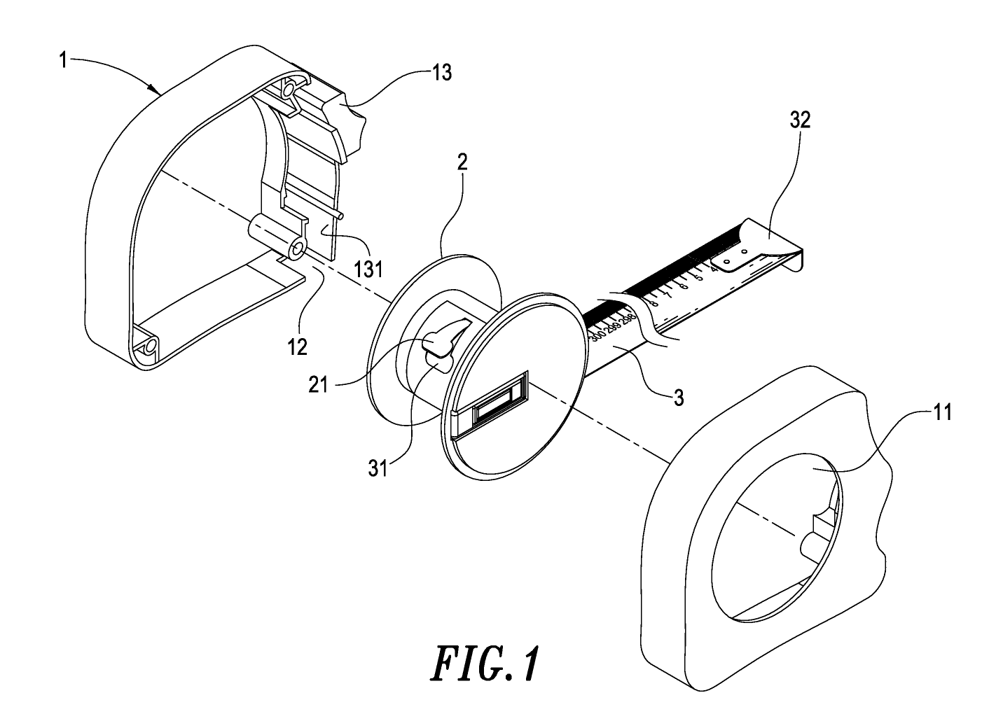

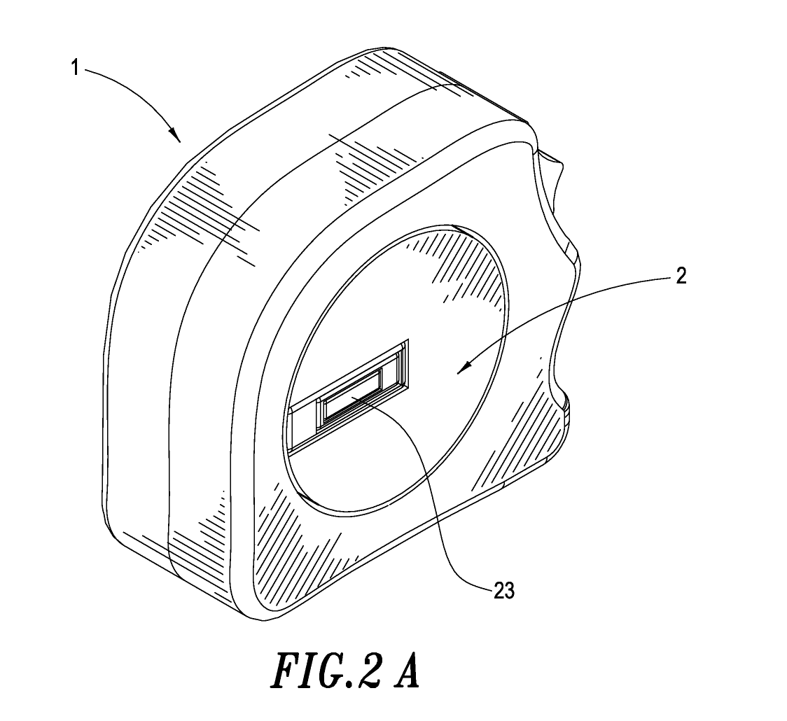

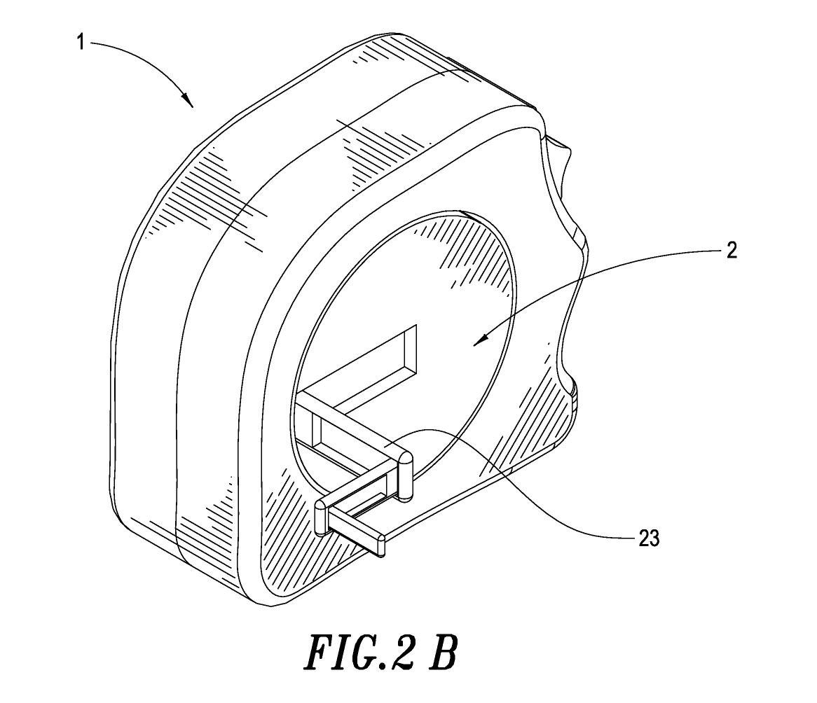

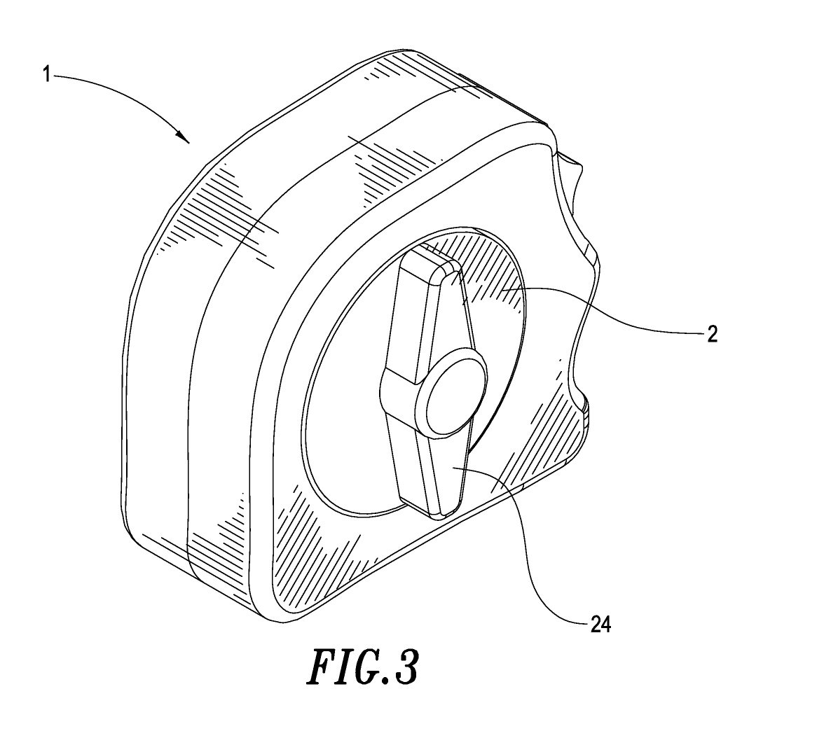

Please refer to FIG. 1, FIG. 2A and FIG. 2B showing an enhanced structure for measuring tape, which includes a tape casing 1, a slightly I-shaped wheel 2 and tape 3.

The tape casing 1 has two casing bodies combining with each other. A first casing body has an opening 11 disposed thereon, and a tape outlet 12 is disposed at a lower front side of tape casing 1. A brake portion 13 is combined with the front side of tape casing 1 for clipping and releasing the tape 3.

The slightly I-shaped wheel 2 has a positioning plate 21 extended therefrom, and a recess 22 is disposed on the surface of wheel 2. The recess 22 has a retracting device disposed on one side thereof, as shown in FIG. 1. The retracting device can be a joystick 23 consisted of a plurality of support bars joining with each other, therefore, joystick 23 can be accommodated in recess 22. Besides, the retracting device can be a push block 24 or a pit 25 for one to place his/her finger thereon, or any other devices which can reel wheel 2.

The tape 3 made of a metallic material has a positioning hole 31 disposed at a tail portion thereof. The positioning hole 31 at tail portion of tape 3 is fixedly combined with the positioning plate 21 of the wheel 2. The tape 3 is wound on wheel 2 to generate an elastic force due to its metallic characteristics;

The wheel 2 with the tape 3 wound thereon is disposed fixedly in tape casing 1 so as to let the surface of wheel 2 have retracting device 23 disposed thereon to protrude out of opening 11 of tape casing 1, and a tape head 32 of tape 3 to protrude out of the tape outlet 12 of tape casing 1 for the tape 3 to eject from the tape outlet 12 on the front side of the tape casing 1.

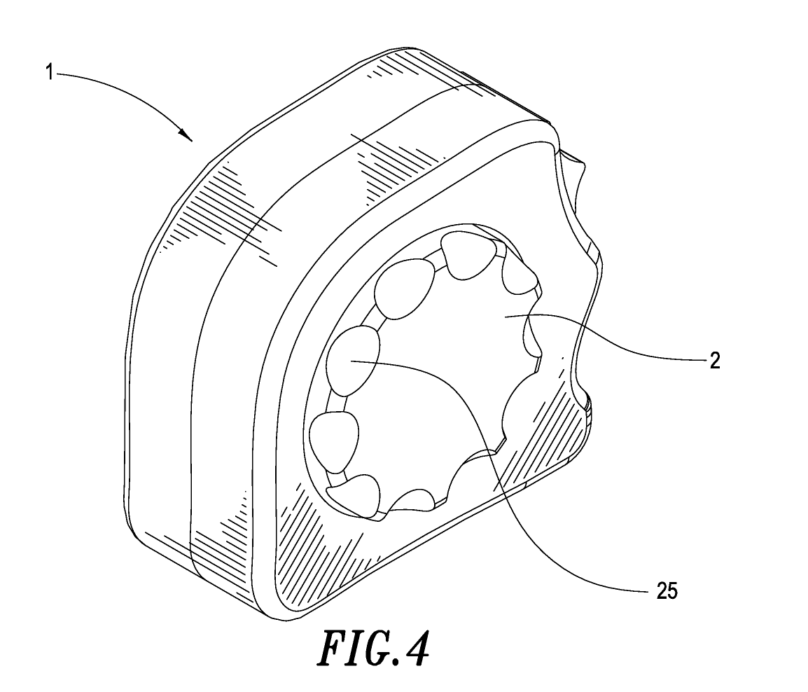

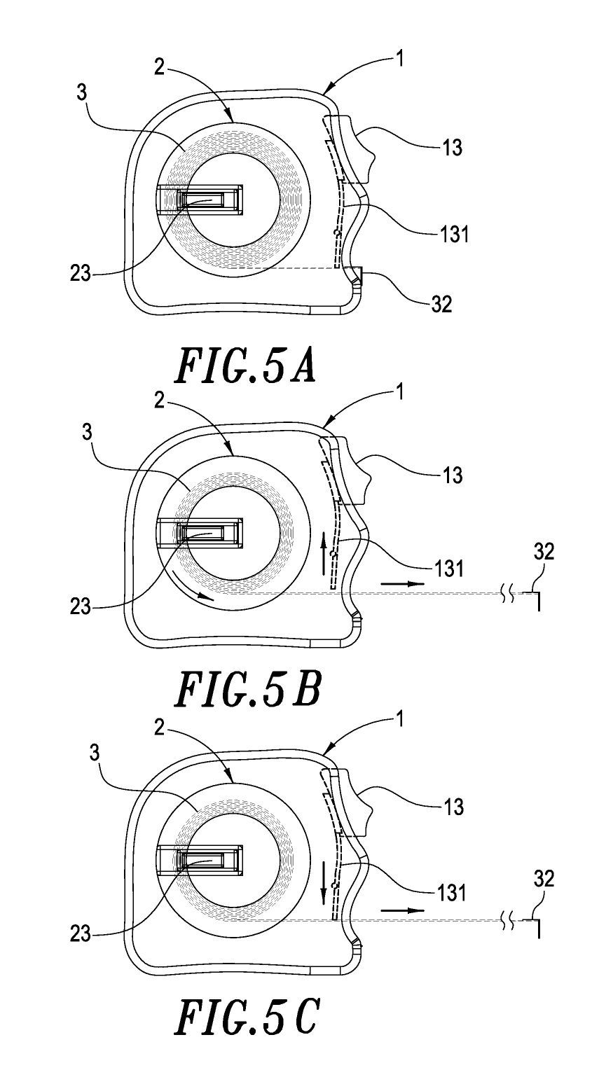

Please refer to FIGS. 5A, 5B and 5C concurrently for the enhanced structure for measuring tape in which the tape is being released. When one wants to release tape 3, he/she can separate a brake plate 131 of brake portion 13 on the front side of casing 1 from tape 3, then the elastic force generated by wound tape 3 would the let tape 3 to automatically and continuously eject from the tape outlet 12 of the casing 1. When the ejected tape has achieved a required length, one can press the brake plate 131 of the brake portion 13 against the tape 3 to the clip tape 3, then the tape 3 will stop ejecting, thereby implementing the automatic ejection movement of the tape 3.

Besides, tail portion of the tape 3 is fixedly combined with the positioning plate 21 of wheel 2 so as to prevent the tail portion from ejecting out of the casing 1 of measuring tape.

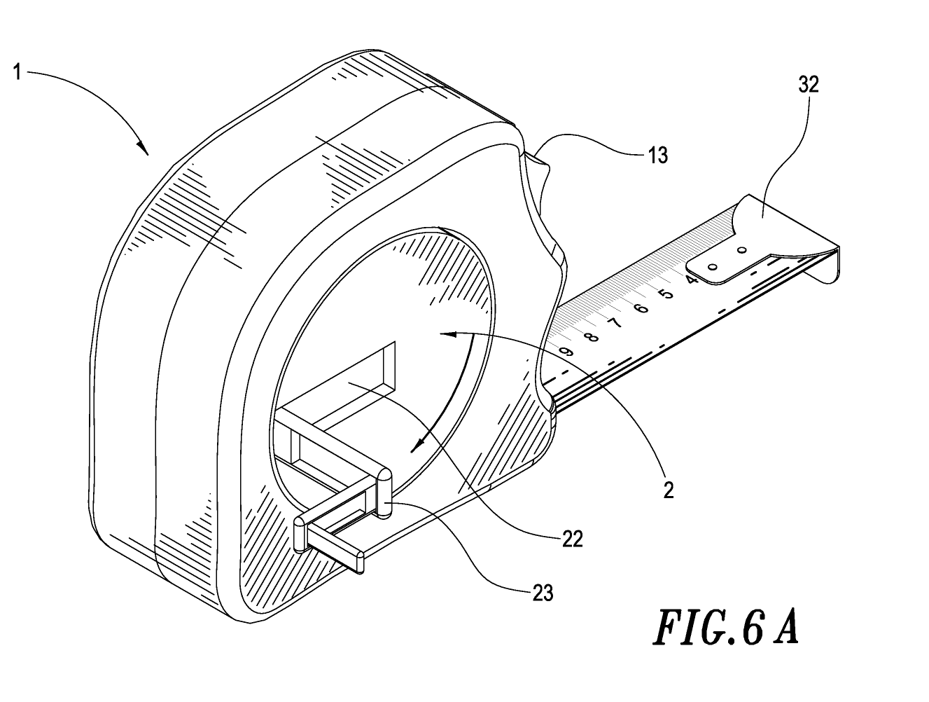

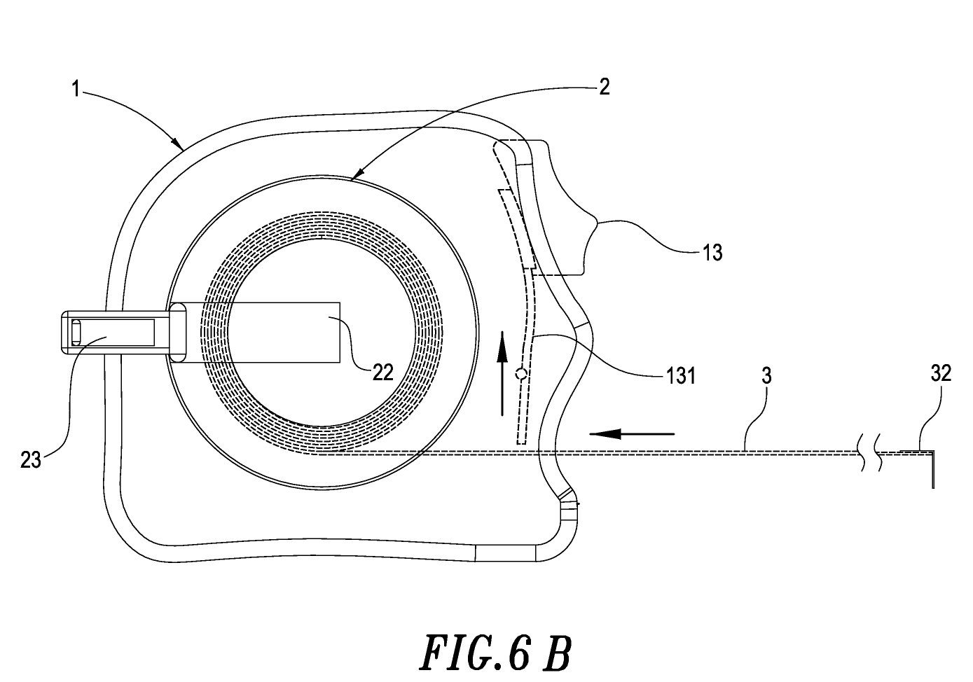

Please refer to FIGS. 6A and 6B concurrently for the enhanced structure for measuring tape in which the tape is being retracted. When one wants to retract the automatically ejecting tape 3, he/she needs to separate the brake plate 131 of brake portion 13 on the front side of casing 1 from the tape 3, then uses the retracting device protruded out of casing 1 to turn the wheel 2 in an opposite direction to wind the tape 3 back into the casing 1. When the tape 3 is being completely wound around wheel 2, one can press the brake plate 131 of brake portion 13 against the tape 3 to clip the tape 3, thereby implementing the manual retraction movement of tape 3.

Furthermore, the tail portion of tape 3 can be fixed to the wheel 2 directly without connecting to the wheel 2 via the positioning plate 21 (not shown in figure).

The present invention provides an enhanced structure for measuring tape, which compares with other traditional measuring tapes, has advantages as follows.

1. The present invention provides an enhanced structure for measuring tape which lets the tape to eject automatically and continuously, while retracts the tape back into the casing manually to facilitate the ejection/retraction of the tape and to avoid hurting users during fast retraction movement.

2. The present invention provides an enhanced structure for measuring tape which eliminates the use of spring to save cost.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An enhanced structure for measuring tape, comprises:
a tape casing having an opening disposed on a surface thereof, and a tape outlet being disposed at a lower end of a front side of the tape casing, a brake portion being combined with the front side of the tape casing for clipping and releasing a tape;
a wheel having a retracting device disposed on a surface thereof;
the tape having a tail portion fixedly combined with the wheel, the tape being wound on the wheel to generate an elastic force;
the wheel with the tape wound thereon being disposed fixedly in the tape casing so as to let the surface of the wheel having the retracting device disposed thereon to protrude out of the opening of the tape casing, and a tape head of the tape protruding out of the tape outlet of the tape casing for the tape to eject from the tape outlet on the front side of the tape casing.

2. The enhanced structure for measuring tape as recited in claim 1, wherein the retracting device of the wheel is a joystick for retracting the tape on the wheel back into the tape casing.

3. The enhanced structure for measuring tape as recited in claim 2, wherein the joystick is consisted of a plurality of support bars joining with each other, and a recess being disposed on the same surface, the recess being provided for accommodating the retracting device in position.

4. The enhanced structure for measuring tape as recited in claim 1, wherein the retracting device of the wheel is a push block for retracting the tape on the wheel back into the tape casing.

5. The enhanced structure for measuring tape as recited in claim 1, wherein the retracting device of the wheel is a pit for a user to place his/her finger thereon to move the pit to retract the tape on the wheel back into the tape casing.

6. The enhanced structure for measuring tape as recited in claim 1, wherein the tape is made of a metallic material so as to generate elastic force when being wound.

7. An enhanced structure for measuring tape, comprises:
a tape casing having an opening disposed on a surface thereof, and a tape outlet being disposed at a lower end of a front side of the tape casing, a brake portion being combined with the front side of the tape casing for clipping and releasing a tape;
a wheel, the wheel having a positioning plate extended therefrom and a retracting device disposed on a surface thereof;
the tape having a positioning hole disposed at a tail portion thereof, the positioning hole at the tail portion being fixedly combined with the positioning plate of the wheel, the tape being wound on the wheel to generate an elastic force;
the wheel with the tape wound thereon being disposed fixedly in the tape casing so as to let the surface of the wheel having the retracting device disposed thereon to protrude out of the opening of the tape casing, and a tape head of the tape protruding out of the tape outlet of the tape casing for the tape to eject from the tape outlet on the front side of the tape casing.

8. The enhanced structure for measuring tape as recited in claim 7, wherein the retracting device of the wheel is a joystick for retracting the tape on the wheel back into the tape casing.

9. The enhanced structure for measuring tape as recited in claim 8, wherein the joystick is consisted of a plurality of support bars joining with each other, and a recess being disposed on the same surface, the recess being provided for accommodating the retracting device in position.

10. The enhanced structure for measuring tape as recited in claim 7, wherein the retracting device of the wheel is a push block for retracting the tape on the wheel back into the tape casing.

11. The enhanced structure for measuring tape as recited in claim 7, wherein the retracting device of the wheel is a pit for a user to place his/her finger thereon to move the pit to retract the tape on the wheel back into the tape casing.

12. The enhanced structure for measuring tape as recited in claim 7, wherein the tape is made of a metallic material so as to generate elastic force when being wound.
